(19) United States
(12) Patent Application Publication
(10) Pub. No.: US 2023/0265826 A1
(43) Pub. Date: Aug. 24, 2023

(54) ROTOR BLADE OF A WIND POWER INSTALLATION

(71) Applicant: Wobben Properties GmbH, Aurich (DE)

(72) Inventors: Christian Möller, Aurich (DE); Jochen Stemberg, Aurich (DE); Ralf Messing, Aurich (DE)

(21) Appl. No.: 18/167,636

(22) Filed: Feb. 10, 2023

(30) Foreign Application Priority Data
Feb. 21, 2022 (DE) 102022104017.8

(51) Int. Cl. F03D 1/06

(52) U.S. Cl. CPC F03D 1/0641; F03D 1/0683; F05B 2240/302; F05B 2240/231; F05B 2240/304; F05B 2240/305; F05B 2240/301; F05B 2250/712

(57) ABSTRACT

The present disclosure relates to a rotor blade of a wind power installation, at least comprising a first rotor blade component having: a first end for arranging on the wind power installation, and a second end for connecting to a second rotor blade component; a second rotor blade component having: a first end for arranging on the first rotor blade component, and a second end wherein the first rotor blade component can be connected to the second rotor blade component at a separating point to the rotor blade, wherein the rotor blade has an aerodynamically open profile at the separating point.

### BACKGROUND

### Technical Field

The present invention relates to a rotor blade for a wind power installation, and a wind power installation having a rotor blade of this kind.

### Description of the Related Art

Wind power installations are generally known in the art and are usually configured as lift-based wind turbines with a horizontal axis and three rotor blades on the windward side.

In addition to the prevailing wind conditions at the site of the wind power installation, the length and shape of the rotor blades in this case are crucial to the yield of a wind power installation. In particular, as the length of the rotor blades increases, the yield of the wind power installation can be improved.

Long rotor blades are desirable to this extent.

However, as the length of the rotor blades increases, so do the structural requirements, e.g., in terms of weight or flow behavior.

Added to this is the fact that logistical requirements have to be taken into account in relation to transportation to the site of the wind power installation, which means that rotor blades with a length of over 70 meters frequently have to have a multi-part design. This means, in particular, that the rotor blades are shipped from the factory in multiple parts and are only assembled at the site of the wind power installation.

Assembly in this case involves the use of bolts, for example, which require a material thickening at the corresponding point (separating point), which can lead to a profile shift which may have a detrimental effect on the flow behavior of the rotor blade.

To this extent, separate profiles are needed for divided rotor blades.

### BRIEF SUMMARY

Provided is a divided rotor blade which meets the aerodynamic requirements of long rotor blades.

In one aspect, a rotor blade of a wind power installation is thereby proposed, comprising at least a first rotor blade component with a first end for arranging on the wind power installation, and a second end for connecting to a second rotor blade component; a second rotor blade component having a first end for arranging on the first rotor blade component, and a second end, wherein the first rotor blade component can be connected to the second rotor blade component at a separating point to the rotor blade, wherein the rotor blade has an aerodynamically open profile at the separating point.

The separating point preferably separates the rotor blade in the longitudinal rotor blade direction, so that the first rotor blade component can also be referred to as a root component and the second rotor blade component can also be referred to as a blade tip component. Independently of this, both the rotor blade component and the blade tip component may even be made up of multiple individual parts in some embodiments, for example they may also have one or multiple separating points.

An at least two-part rotor blade of a wind power installation is therefore proposed, which has an aerodynamically open profile, at least at one separating point, in particular between the first rotor blade component and the second rotor blade component.

An aerodynamically open profile can be achieved, for example, in that the upper side or suction side of the rotor blade, and the lower side or pressure side of the rotor blade, are spaced apart from one another at the trailing edge of the rotor blade. In particular, an aerodynamically open profile should be distinguished from an aerodynamically closed profile, in which an outflow point on the pressure side corresponds to the outflow point on the suction side.

An aerodynamically open profile in this case is therefore understood to mean an aerodynamic profile in which a flow at a leading edge is divided into a flow over the suction side and a flow over the pressure side, and this divided flow flows away at two points spaced apart from one another on the suction side and the pressure side.

A possible way of realizing an aerodynamically open profile is a so-called “blunt” or “thick” trailing edge, in which the trailing edge has a finite extent between a trailing edge on the pressure side and a trailing edge on the suction side. Other possibilities are, for example, the provision of flow-influencing attachments such as Gurney flaps, wherein a flow-off point on the pressure side is normally the tip of the Gurney flap. C-shaped or hollow profiles are also possible.

The rotor blade may therefore also have further segments or components, in addition to the first rotor blade component and the second rotor blade component, such as a particularly additional trailing edge segment, for example. The substantial shape and appearance of the rotor blade is, however, determined by the first and second rotor blade components, which are preferably connected to the actual rotor blade, particularly in a form-fitting manner, along the length.

The first rotor blade component, also referred to as the component close to the hub, preferably has a first end which is designed to be connected to the wind power installation, in particular to a (rotor) hub of the wind power installation. The first end is preferably designed as a blade flange or blade root for this purpose.

The first rotor blade component has, in addition, a second end which is set up to be connected to the second rotor blade component, in particular to a first end of the second rotor blade component, for example by bolts or adhesive bonding or stitch-bonding.

The second rotor blade component, also referred to as the component remote from the hub, preferably has a first end which is set up to be connected to the first rotor blade component, in particular to a second end of the first rotor blade component, for example by bolts or adhesive bonding or stitch-bonding.

The second rotor blade component also has a second end which is substantially tapered in design, preferably pointed, and/or is designed as the tip of the rotor blade.

The rotor blade also has a separating point which preferably runs substantially transversely to the longitudinal direction of the rotor blade.

The rotor blade components are connected to one another at each separating point, in particular in such a manner that the total of the lengths of the rotor blade components substantially produces the length of the rotor blade.

The separating point also has a material thickening, a so-called preform thickening. This can be achieved, for example, in that the second end of the first rotor blade component and the first end of the second rotor blade component are thickened with material, for example through additional layers of glass-fiber-reinforced plastic (GFK) and/or carbon-fiber-reinforced plastic (CFK), or the like.

The rotor blade preferably has a progression with different profiles in the rotor blade longitudinal direction, each profile having a leading edge, a trailing edge, and flow surfaces on the pressure side and the suction side connecting the leading edge and trailing edge, wherein the trailing edge in at least one portion in the rotor blade longitudinal direction, in which the separating point lies, is designed as a thick trailing edge and therefore forms the aerodynamically open profile.

In the case of thick trailing edges, a direction of the thickness of the trailing edge may be oriented substantially parallel to the rotor blade thickness and at right angles to the rotor blade length and at right angles to the rotor blade depth. However, a thickness of the trailing edge of the rotor blade may also be defined for profiles of this kind, which have rounded corners or also structurally closed profiles, in particular in a drop shape.

In this case, the trailing edge contour on the pressure side or on the suction side, respectively, preferably forms a flow-off edge in each case. With profiles of this kind, particularly in the profile section, the spacing of the flow-off point on the suction side and the flow-off point on the pressure side is understood to mean the thickness of the trailing edge. In other words, the flow-off edges in the profile progression connect the flow-off points of the associated profile sections in each case. In order to define the thickness of the trailing edge, the flow-off point in each case is defined, in particular, as the local camber maximum, both on the pressure side and on the suction side. Customarily, more than a local camber maximum can occur both on the pressure side and on the suction side, wherein in this case, the respective flow-off point is the local camber maximum furthest away from the leading edge.

The trailing edge in this case may be an integral constituent of the first and/or the second rotor blade component, or a one-part or multi-part component, which is fastened, or will be fastened, to the first and/or the second rotor blade component, for example by bolts or adhesive bonding.

The thick trailing edge is preferably formed by flow surfaces on the pressure side and the suction side spaced apart on the trailing edge, i.e., flow-off points spaced apart in each case, wherein the space between the flow surface on the pressure side and on the suction side on the trailing edge is referred to as the thickness of the trailing edge.

A progression of the thickness of the trailing edge preferably has at least a maximum and the thickness of the trailing edge in the region of the separating point is particularly preferably at least 50 percent, preferably 60 percent, more preferably 80 percent, of this maximum.

Alternatively or in addition, the maximum lies in a region about the separating point, wherein the region about the separating point lies between 15 percent and 40 percent of the length of the rotor blade and/or the region is smaller than 10 percent of the length of the rotor blade.

The thickness of the trailing edge is an absolute value which adopts an easy-to-determine progression over the length of the rotor blade, irrespective of other geometric parameters of the rotor blade. The fact that the thickness of the trailing edge is at a maximum in a particular region, namely in relation to the position of the separating point, means that a particularly advantageous rotor blade results.

In this case, the thickness of the trailing edge at the separating point may have a minimum value relative to the maximum thickness of the trailing edge and/or the position of the maximum may not be more than a given amount away from the separating point. In both alternative and supplementary descriptions, there is therefore a correlation between the position of the separating point and the thickness of the trailing edge.

If in a blade design, for example, a maximum thickness of the trailing edge wanders further in the direction of the rotor blade tip, it has proved advantageous for the separating point also to be placed correspondingly further in the direction of the rotor blade tip. In other words, it has proved advantageous for the progression of the thickness of the trailing edge to be adapted to the position of a fixed separating point.

While in this embodiment the absolute value of the thickness of the trailing edge is used, in other embodiments comparable relationships with thicknesses of the trailing edge relative to the rotor blade thickness or the rotor blade depth, so relative trailing edge thicknesses relative to the rotor blade thickness and/or relative to the rotor blade depth, can also be used. Here, too, it has been shown that it is advantageous for a corresponding local maximum of the progression of the relative thickness of the rear edge to be formed, with the position of which the position of the separating point is aligned.

In one embodiment, the separating point is closer to the rotor blade tip of the rotor blade than the maximum thickness of the trailing edge.

It is therefore initially advantageous for the trailing edge to converge in the region of the separating point in the longitudinal direction of the rotor blade, in other words for the trailing edge on the pressure side and the trailing edge on the suction side to converge with one another. In addition, it is advantageous for the position of the separating point in the longitudinal direction of the rotor blade to lie behind, not in front of, the maximum. The additional structural requirements and therefore, for example, weight increases at the separating point, result in additional structural loads through the separating point, the effects of which can at least be mitigated through the arrangement behind the maximum, in other words closer to the rotor blade tip.

In other embodiments, it has proved advantageous for a thick trailing edge to be provided in the environment of the rotor blade hub. Instead of the progression with the maximum thickness of the trailing edge in the region of the separating point, the maximum thickness of the trailing edge may abut against the blade root.

Advantageously, the progression of the thickness of the trailing edge in this embodiment is monotonically decreasing, in other words it decreases monotonically as the distance from the rotor blade root increases. The maximum thickness of the trailing edge is therefore formed at, or in, the environment of the rotor blade root.

Particularly preferably, a particular progression of the change in thickness of the trailing edge is provided in this embodiment. The change in thickness of the trailing edge may be expressed, particularly preferably, as a derivative of the thickness of the trailing edge in the longitudinal direction, or also the radial direction, of the rotor blade. A monotonically decreasing progression of the thickness of the trailing edge therefore has a derivative which is negative over the entire rotor radius, or in any event not positive, in other words a “negative” change.

In particular, from a given region in the rotor blade direction, from which the trailing edge no longer shows a finite extent or thickness, there will also be no further change in the thickness of the trailing edge.

Particularly preferably, a local maximum of the change in thickness of the trailing edge lies at the separating point or in a region about the separating point, wherein the region about the separating point is between 15 percent and 40 percent of the length of the rotor blade and/or the region is smaller than 10 percent of the length of the rotor blade.

In one alternative, the absolute position of the region relative to the rotor blade is therefore formulated. In the other alternative, the extent of the region relative to the separating point is formulated.

The fact that the local maximum lies within the region preferably means in this case that within the region on both sides of the local maximum there is already a greater change in thickness of the trailing edge in terms of amount. In other words, the local maximum is, in particular, not a value at the periphery of the region.

Particularly preferably, the local maximum change in thickness is located in a region smaller than 5 percent of the length of the rotor blade about the separating point.

In one embodiment, the pressure side has a concave progression at the separating point in the region of the trailing edge.

A concave progression of the pressure side means that the pressure side has a progression in the region of the trailing edge which curves inwards, so in the direction of the suction side.

In one embodiment, a camber of the pressure side at the separating point in the region of the trailing edge is greater in terms of amount than the camber of the suction side at the separating point in the region of the trailing edge.

In this way, the profile at the separating point at the trailing edge can be regarded as diverging. Advantageously, two tangents diverge, which are each placed at the flow-off point on the suction side and the flow-off point on the pressure side, behind the trailing edge.

In one embodiment, a direct connection between the leading edge and the trailing edge is referred to as the chord and the length thereof as the profile depth, a greater distance between the profile surface on the pressure side and the suction side perpendicularly to the profile depth is referred to as the profile thickness and a ratio of profile thickness to profile depth is referred to as the relative thickness, wherein a progression of the relative thickness over the rotor blade length is referred to as the thickness progression.

In one embodiment, a change in the thickness progression in the region of the separating point has a local maximum.

In this embodiment, a region of 5% of the rotor blade length, also referred to as 5% L, is preferably understood as the region of the separating point, in the middle of which the separating point is located. The fact that the change in the thickness progression has a local maximum in the region of the separating point means that after the separating point, in other words viewed from the separating point in the direction of the rotor blade tip, a rapid reduction in the relative thickness can take place. In this way, the structurally caused and aerodynamically disadvantageous reinforcements at the separating point can be compensated for as quickly as possible, which leads to a more efficient rotor blade.

This preferred description of the region of the separating point can likewise be applied in designs to the thickness of the trailing edge or the change in thickness of the trailing edge.

Particularly preferably, the thickness progression has a plateau right at the separating point, so that the change in the thickness profile is a minimum right at the separating point. This is the case, since the absolute thickness profile exhibits a maximum through thickening, or the like, at the separating point, in order to receive the fastening bolts to fasten the rotor blade components.

In one embodiment, the change in the thickness progression is defined as a deviation in the thickness progression following the direction of the rotor blade length.

In one embodiment, a camber of the thickness progression changes direction in the region of the separating point, wherein the camber is particularly defined as the second deviation of the thickness profile following the direction of the rotor blade length and the direction changes when the algebraic sign changes.

In one embodiment, the change in the thickness progression has an asymmetric design about the separating point. This means that the change in the thickness progression in front of the separating point is greater or smaller at at least one point than at a corresponding position behind the separating point. In this case and in the following, the phrase “in front of the separating point” is understood to mean the part of the rotor blade from the rotor blade hub to the separating point and “behind the separating point” is understood to mean the part of the rotor blade from the separating point to the rotor blade tip.

Particularly preferably, the rotor blade has in a total region of 5% closer to the hub of the separating point a smaller or equal reduction in the thickness progression than symmetrically in the region of 5% closer to the hub of the separating point, wherein particularly preferably at a position 5% closer to the hub of the separating point, a smaller reduction in the thickness progression than at a position 5% closer to the hub of the separating point is formed.

In this embodiment, the greater reduction behind the separating point enables aerodynamically advantageous thin profiles to be quickly achieved behind the separating point.

The relative thickness at the separating point is preferably between 40% and 80%.

A relative position of the maximum profile thickness, relative to the chord, is referred to as the thickness reserve. In one embodiment, the thickness reserve at the separating point is smaller than 30%. This means that the maximum profile thickness is significantly in front of the midpoint of the profile depth in the direction of the leading edge, which contributes to an aerodynamically advantageous rotor blade.

A connection of the incircles of the profile is referred to as the camber line. A curvature is defined as the distance of the camber line from, and perpendicularly to, the chord. In one embodiment, a progression of the curvature along the profile depth displays a maximum in the rear 50%, measured from the leading edge.

The term “maximum” does not imply that the curvature has to be positively formed in any region. If the curvature runs negatively over the entire profile depth, the maximum of the curvature is correspondingly a minimum in terms of amount.

An algebraic sign of the curvature preferably changes in the front 70% of the profile depth, measured from the leading edge, in particular in a region between 40% and 70% of the profile depth.

The algebraic sign of the curvature may also be differently expressed as a position of the center of the incircles in relation to the chord. A positive algebraic sign is preferably fixed in the case of a curvature in the direction of the suction side, a negative algebraic sign in the case of a curvature in the direction of the pressure side.

A value of the curvature at the separating point at each position in the profile depth direction is preferably between plus and minus 10%, in particular between plus and minus 7%, relative to the profile depth at the separating point.

Particular advantages result from a combination of this curvature distribution with the thickness reserve at the separating point described above.

The rotor blade advantageously has a length of at least 70 m, preferably at least 80 m, more preferably at least 100 m.

The maximum profile depth of the rotor blade is advantageously at most 6.5% of the length of the rotor blade.

The profile depth is particularly determined as the depth of the profile-defining contour without attachments. Complying with this upper limit for the maximum profile depth enables the blade mass, structural complexities and transport dimensions to be observed. For example, even with a rotor blade with a 95 m rotor blade length, the profile depth may be substantially below the limit of 6.5% and, for example, be at most 4.10 m, in order to avoid transport restrictions.

The rotor blade preferably has at least one vortex generator and/or a Gurney flap and/or a splitter plate and/or a boundary layer fence and/or serrations, in particular at, or on, the first and second elongate body.

By means of these, or other, preferred attachments, either individually or in combination, the positive properties of the rotor blade according to the invention can be further improved.

The first rotor blade component preferably has a length and the second rotor blade component a length, wherein the length of the first rotor blade component is shorter than the length of the second rotor blade component, in particular such that the separating point is arranged in a region of the rotor blade of between 20 percent and 35 percent of the length of the rotor blade.

In a further aspect, a wind power installation having at least one rotor blade according to an aspect described above is proposed.

Finally, in a further aspect, a wind park with multiple wind power installations according to the aspect described above is proposed.

Both the wind power installation and the wind park enable the same advantages, in particular with correspondingly large dimensions, to be achieved, as are described for the rotor blade according to the disclosure. In addition, particular advantages result through the combination with one or more of the embodiments described as preferred.

### BRIEF DESCRIPTION OF THE SEVERAL VIEWS OF THE DRAWINGS

The present disclosure is explained in greater detail below with the help of the accompanying figures, wherein the same reference signs are used for the same or similar assemblies.

FIG. 1 shows schematically and by way of example a perspective view of a wind power installation.

FIG. 2 shows schematically and by way of example a rotor blade of a wind power installation, in particular in three views.

FIG. 3 shows schematically and by way of example a profile of a rotor blade of a wind power installation at a separating point of the rotor blade, in particular in cross section.

FIG. 4 shows schematically and by way of example a progression of part of a profile of a rotor blade of a wind power installation along a length of the rotor blade.

FIG. 5 shows schematically and by way of example a progression of a thickness of the trailing edge and an associated trailing edge along a length of the rotor blade.

### DETAILED DESCRIPTION

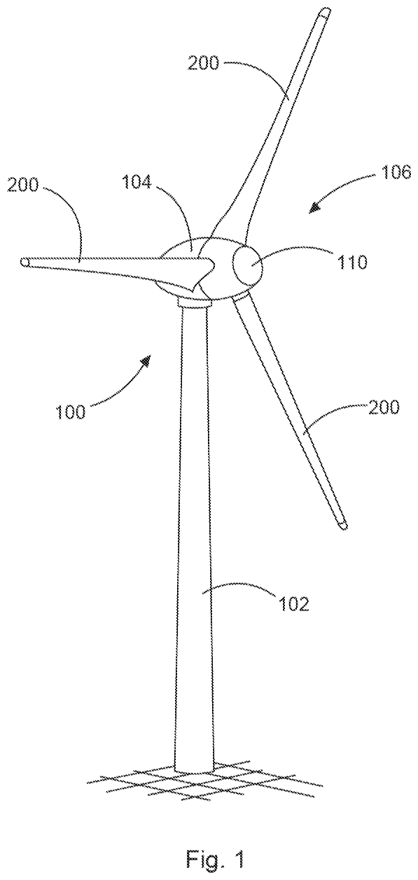

FIG. 1 shows schematically and by way of example a perspective view of a wind power installation 100. The wind power installation 100 is designed as a lift-based wind turbine with a horizontal axis and three rotor blades 200 on the windward side, in particular as a horizontal rotor. The wind power installation 100 has a tower 102 and a nacelle 104.

An aerodynamic rotor 106 with a hub 110 is arranged on the nacelle 104. Three rotor blades 200 are arranged on the hub 110, particularly symmetrically to the hub 110, preferably offset by 120°. The rotor blades 200 are preferably configured as described above and/or below.

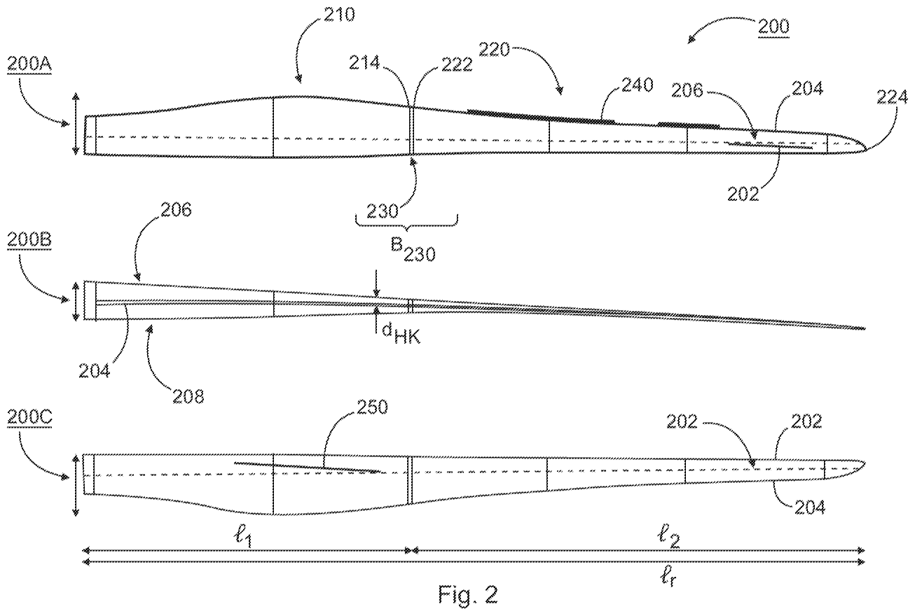

FIG. 2 shows schematically and by way of example a rotor blade 200 of a wind power installation, as shown in FIG. 1, for example, in three views 200A, 200B, 200C.

The rotor blade 200 has a leading edge 202, a trailing edge 204, a suction side 206, a pressure side 208 and a length 1 r. In the first view 200A the rotor blade 200 in this case is shown from above, so with a view to the suction side 206.

In the second view 200B, the rotor blade 200 is shown from behind, so with a view to the trailing edge 204.

In the third view 200C, the rotor blade 200 is shown from below, so with a view to the pressure side 208.

The rotor blade 200 is designed as a two-part rotor blade 200, namely made up of a first rotor blade component 210 and a second rotor blade component 220, which can be assembled at a separating point 230 into the actual rotor blade 200. Functional or structural measures are needed for this purpose, for example, which extend from the separating point into the rotor blade components 210, 220, in particular in a region B₂₃₀ about the separating point.

For transport reasons, the rotor blade 200 is typically divided into individual rotor blade components 210, 220, transported to the erection site of the wind power installation 100 and assembled on site. For this purpose, structural precautions have to be taken at the separating point 230, for example thicker material layers, in order to guarantee a reliable connection on site by bolts or by adhesive bonding, for example.

Consequently, it is usually unavoidable for a greater weight, and possibly even further unwanted, for example aerodynamic effects, such as disadvantageous induction factors or elasticities, for example, to occur in the region of the separating point 230, so in the region B₂₃₀. The present disclosure acknowledges these disadvantages in the use of divided rotor blades and enables the most efficient rotor blade possible to be created under these marginal conditions which are taken as given.

The first rotor blade component 210 and the second rotor blade component 220 are connected to one another, particularly along the length, in other words so that the rotor blade 200 has a length 1 r which is substantially made up of the length l₁ of the first rotor blade component 210 and the length l₂ of the second rotor blade component 220.

The first rotor blade component 210 comprises a first end 212 for arranging on a blade connection of the wind power installation 100 and a second end 214 which is connected, in particular, to the first end 222 of the second rotor blade component 220. The first rotor blade component 210 may also be referred to as the rotor blade component close to the hub.

The second rotor blade component 220 comprises a first end 222 which is connected to the second end 214 of the first rotor blade component 214 and a second end 224 which can also be referred to as the rotor blade tip.

The second rotor blade component 220 is preferably substantially longer than the first rotor blade component 210, in particular such that the separating point lies in a region between 15 percent and 40 percent of the length lᵣ of the rotor blade 200.

In addition, the rotor blade has optional serrations 240 on the trailing edge 206, in particular on the second rotor blade component 220, and also a Gurney flap 250 on the pressure side 208. The Gurney flap 250 extends particularly preferably both over part of the first rotor blade component 210 and over part of the second rotor blade component 220 and is therefore arranged in the region of the separating point 230, in particular.

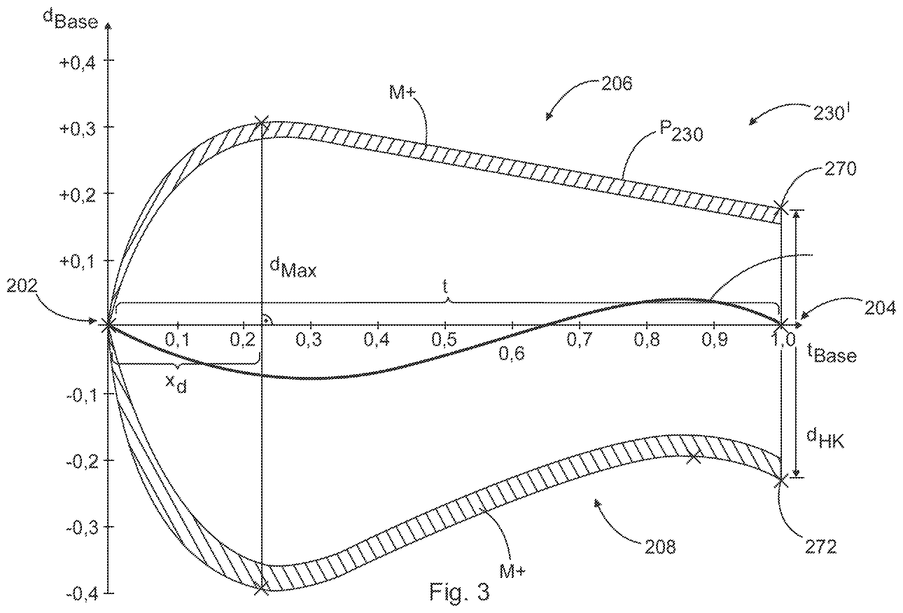

The rotor blade 200 also has, in particular, an aerodynamically open profile (P) at the separating point 230, as shown in FIG. 3, for example.

FIG. 3 shows schematically and by way of example a profile P₂₃₀ of a rotor blade, for example as shown in FIG. 2, at a separating point 230 of the rotor blade in a view 230′, in particular in cross section.

The profile P₂₃₀ of the rotor blade 200 at the separating point 230 can therefore be seen from FIG. 3, in particular.

Particularly in the region of the separating point 230, the profile of the rotor blade 200 is not closed; in this example the rear edge has a finite thickness d_{HK}. This means, in particular, that a flow-off point 270 on the suction side 206 and a flow-off point 272 on the pressure side 208 are spaced apart from one another at a distance of d_{HK} on the trailing edge.

While a traditional “thick trailing edge” is shown in FIG. 3, in which the trailing edge is virtually perpendicular to the profile depth t and in which a sharp edge is provided to the respective flow-off points on the pressure side 208 and suction side 206, an aerodynamically open profile of the present invention is not limited to this.

The shape of the trailing edge may also be curved and is not limited to a straight line. The direction of the trailing edge may also deviate from a direction which is perpendicular to the profile depth. Finally, there is also no need for an acute transition between the trailing edge and the pressure side 208 or else the suction side 206. For example, a continuous or rounded transition may also be provided. The thickness of the trailing edge d_{HK} is then determined as the space between the local camber maximums in each case on the pressure side 208 or the suction side 206, which then define the respective flow-off points 270, 272.

To provide a better understanding and, in particular, in order to illustrate the relationships described herein, the view 230′ is supplemented by a Cartesian coordinate system. In this case, the local profile depth t_{base} is plotted as a percentage on the x-axis of the coordinate system. In addition, the local profile thickness dbase is plotted as a percentage on the y-axis of the coordinate system, particularly in relation to the profile depth.

Both the second end 214 of the first rotor blade component 210 and the first end 222 of the second rotor blade component 220 preferably exhibit the profile P₂₃₀. This particularly enables a form fit of the two rotor blade components 210, 220 at the separating point 230 of the rotor blade 200.

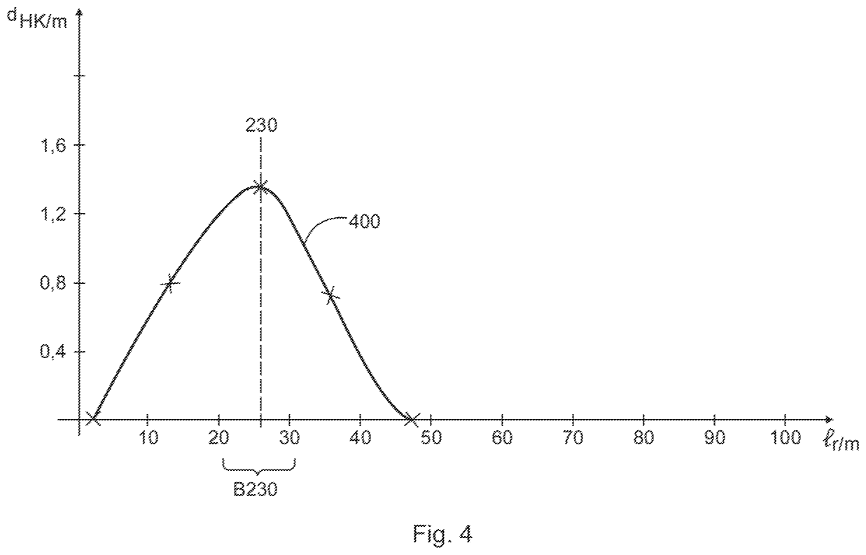

The profile P₂₃₀ is aerodynamically open, i.e., the upper side 206 and the lower side 208 of the rotor blade are spaced apart from one another at the trailing edge 204 by a thickness d_{HK}, for example by 1.5 m or as shown in FIG. 4.

The profile P₂₃₀ has a chord t which runs directly between the leading edge 202 and the trailing edge 204.

The profile P₂₃₀ has, in addition, a profile thickness d, the local maximum dₘₐₓ of which lies at approx. 22 percent of the profile depth. This means, in particular, that the rotor blade has its maximum thickness at approx. 22 percent profile depth. The distance between the leading edge 202 and the point of the maximum thickness dₘₐₓ of the profile P₂₃₀ is also referred to as the thickness reserve x_{d}. The ratio of the thickness reserve x_{d} to the profile depth t is, in addition, also referred to as the relative thickness reserve x_{d}′.

At the separating point 230, or in the region B₂₃₀ of the separating point 230, the rotor blade 200 has a material thickening M+, which can also be referred to as the preform thickening. The material thickening M+ is preferably more than 0.2 m and less than 1.0 m, preferably between 0.3 m and 0.7 m, in particular approx. 0.5 m. The material thickening M+ in this case should be understood as a structural thickening overall, which may extend both outwardly in a profile-enlarging manner, so as a contour thickening, but also to within the profile.

The rotor blade 200 also has only a slight camber at the separating point 230 or in the region B230 of the separating point 230. The slight camber is illustrated by the flat-running camber line s.

In addition, at the separating point 230, or in the region B230 of the separating point 230, the rotor blade 200 has a back swing, in other words a negative camber, which is illustrated by the negative progression of the camber line. The camber line s therefore has at least one change in algebraic sign, in particular in a region between 40 percent and 70 percent of the length lᵣ of the rotor blade.

FIG. 4 shows schematically and by way of example a progression of the thickness d_{HK} of the trailing edge 204 over the length 1 r of the rotor blade 200.

The trailing edge 204 of the rotor blade comes up to the region B₂₃₀ of the separating point, for example up to 1.5 m, where it reaches its maximum, for example right at the separating point. The trailing edge then tapers to 0 m, for example with a 45 m blade length.

This means, in particular, that the profile P of the rotor blade is open up to a 45 m blade length and is then closed up to the blade tip at 100 m. The profile P of the rotor blade 200 is therefore only open in sections and, in particular, at the separating point 230.

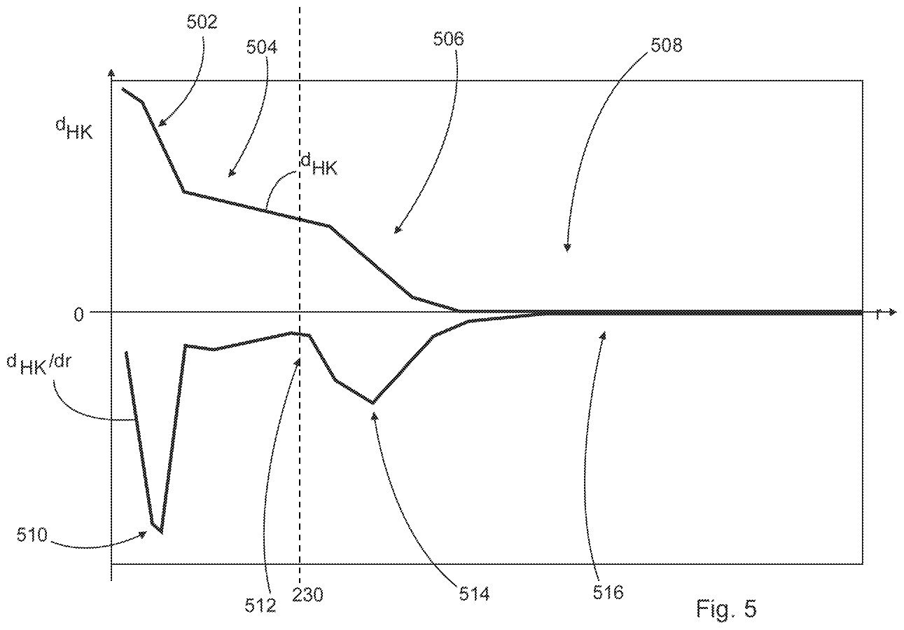

FIG. 5 shows schematically and by way of example an alternative progression of the thickness d_{HK} of the trailing edge 204 over the length lᵣ of the rotor blade 200 and also the associated derivative d_{HK}/dᵣ. Unlike the progression in FIG. 4, the thickness d_{HK} decreases monotonically, so that the maximum is already configured at, or in the environment of, the blade connection.

To begin with, there is a comparatively sharp decrease in the thickness of the trailing edge in a region 502, said trailing edge flattening out in a region 504 and then becoming thicker again in a region 506. In a region 508, the thickness of the trailing edge is zero, meaning that the aerodynamic profile is closed there.

The solution according to the invention can be seen particularly clearly in the lower or negative part of FIG. 5, in which the derivative d_{HK}/dᵣ is shown. The derivative or change in thickness of the trailing edge d_{HK}/dᵣ is negative over the entire rotor blade length, in other words, the thickness of the trailing edge decreases monotonically. The separating point 230 is configured in the region 512, in which the change in thickness of the trailing edge d_{HK}/dᵣ exhibits a local maximum.

Compared with this, the thickness of the trailing edge in the two surrounding regions 510 and 514 is greater, in other words the change in thickness of the trailing edge d_{HK}/dᵣ in the regions 510 and 514 is greater in terms of amount. Since the thickness of the trailing edge is zero in the region 508, the change in thickness of the trailing edge d_{HK}/dᵣ in the corresponding region 516 is likewise zero.

### LIST OF REFERENCE SIGNS

100 Wind power installation

102 Tower

104 Nacelle, in particular of the wind power installation

106 Aerodynamic rotor, in particular of the wind power installation

110 Nacelle, in particular of the wind power installation

200 Rotor blade, in particular of the wind power installation

200A Rotor blade, in particular in a first view

200B Rotor blade, in particular in a second view

200C Rotor blade, in particular in a third view

202 Leading edge, in particular of the rotor blade

204 Trailing edge, in particular of the rotor blade

206 Upper side, in particular of the rotor blade

208 Lower side, in particular of the rotor blade

210 First rotor blade component

212 First end, in particular of the first rotor blade component

214 Second end, in particular of the first rotor blade component

220 Second rotor blade component

222 First end, in particular of the second rotor blade component

224 Second end, in particular of the second rotor blade component

230 Separating point of the rotor blade

230′ View of the separating point

240 Serration

250 Gurney flap

400 Progression of the thickness of the trailing edge over the length of the rotor blade

B230 Region of the separating point

d Profile thickness

d_{base} Local profile thickness

dₘₐₓ Maximum local profile thickness

d_{HK} Thickness of the trailing edge

lᵣ Length of the rotor blade

l1 Length of the first rotor blade component

l2 Length of the second rotor blade component

M+ Material thickening, in particular at the separating point

P Profile of the rotor blade

P₂₃₀ Profile of the rotor blade at the separating point

s Camber line

t Profile depth of the rotor blade

t_{base} (Local) percentage profile depth

x_{d} Thickness reserve

x_{d}′ Relative thickness reserve

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A rotor blade of a wind power installation comprising:
a first rotor blade component having:
a first end for arranging on the wind power installation, and
a second end for connecting to a second rotor blade component, and
a second rotor blade component having:
a first end for arranging on the first rotor blade component, and
a second end,
wherein the first rotor blade component is configured to be connected to the second rotor blade component at a separating point to the rotor blade, and
wherein the rotor blade has an aerodynamically open profile at the separating point.

2. The rotor blade as claimed in claim 1, wherein the rotor blade has a progression with a plurality of different profiles in the rotor blade longitudinal direction, each profile having a leading edge, a trailing edge, and flow surfaces on the pressure side and the suction side connecting the leading edge and trailing edge, and
wherein the trailing edge in at least one portion in the rotor blade longitudinal direction, in which the separating point lies, is designed as a thick trailing edge and forms the aerodynamically open profile.

3. The rotor blade as claimed in claim 2, wherein the thick trailing edge is formed by flow surfaces on the pressure side and the suction side spaced apart on the trailing edge, wherein a space between the flow surface on the pressure side and on the suction side on the trailing edge is considered a thickness of the trailing edge.

4. The rotor blade as claimed in claim 3, wherein a change in the thickness of the trailing edge has a local maximum,
wherein the local maximum lies in a region about the separating point, and
wherein the region about the separating point lies between 15 percent and 40 percent of the length of the rotor blade starting from a rotor blade root and/or the region is smaller than 10 percent of the length of the rotor blade.

5. The rotor blade as claimed in claim 4, wherein a thickness of the trailing edge has a monotonically decreasing progression in the rotor blade longitudinal direction.

6. The rotor blade as claimed in claim 2, wherein the pressure side has a concave progression at the separating point in a region of the trailing edge.

7. The rotor blade as claimed in claim 6, wherein a camber of the pressure side at the separating point in the region of the trailing edge is greater in terms of amount than the camber of the suction side at the separating point in the region of the trailing edge.

8. The rotor blade as claimed in claim 2, wherein:
a direct connection between the leading edge and the trailing edge is a chord and a length thereof as a profile depth,
a greater distance between a profile surface on the pressure side and the suction side perpendicularly to the profile depth is a profile thickness,
a ratio of profile thickness to profile depth is referred to as the relative thickness, and
a progression of the relative thickness over the rotor blade length is a thickness progression and a change in the thickness progression in a region of the separating point has a local maximum.

9. The rotor blade as claimed in claim 8, wherein the change in the thickness progression is defined as a deviation of the thickness progression following the rotor blade longitudinal direction.

10. The rotor blade as claimed in claim 8, wherein a camber of the thickness progression changes direction in the region of the separating point, wherein the camber is defined as the second deviation of the thickness profile following the rotor blade longitudinal direction and the direction changes when an algebraic sign changes.

11. The rotor blade as claimed in claim 1, wherein the relative thickness at the separating point is between 40% and 80%.

12. The rotor blade as claimed in claim 1, wherein a relative position of a maximum profile thickness, relative to the chord, is a thickness reserve, wherein the thickness reserve at the separating point is smaller than 30%.

13. The rotor blade as claimed in claim 1, wherein:
a connection of incircles of the profile is a camber line, wherein a curvature is defined as the distance of the camber line from, and perpendicularly to, the chord, and
a progression of the curvature along the profile depth displays a maximum in the rear 50%, measured from the leading edge.

14. The rotor blade as claimed in claim 13, wherein an algebraic sign of the curvature changes in a front 70% of the profile depth, measured from the leading edge, in a region between 40% and 70% of the profile depth.

15. The rotor blade as claimed in claim 13, wherein a value of the curvature at the separating point at each position in the profile depth direction is between plus and minus 10% relative to the profile depth at the separating point.

16. The rotor blade of a wind power installation as claimed in claim 1, wherein the rotor blade has a length of at least 70 meters.

17. The rotor blade as claimed in claim 16, wherein a maximum profile depth of the rotor blade is at most 6.5% of a length of the rotor blade.

18. The rotor blade of a wind power installation as claimed in claim 1, wherein the rotor blade has at least one component, the component being chosen from a vortex generator, a Gurney flap, a splitter plate, and a boundary layer fence.

19. The rotor blade of a wind power installation as claimed in claim 1, wherein the first rotor blade component has a first length and the second rotor blade component has a second length, wherein the first length of the first rotor blade component is shorter than the second length of the second rotor blade component such that the separating point is arranged in a region of the rotor blade of between 20 percent and 35 percent of a length of the rotor blade.

20. A wind power installation comprising a tower and a rotor blade as claimed in claim 1.

21. A wind park comprising a plurality of wind power installations as claimed in claim 20.
